(19) United States
(12) Patent Application Publication
(10) Pub. No.: US 2024/0316487 A1
(43) Pub. Date: Sep. 26, 2024

(54) SYSTEMS FOR STORING OR TRANSPORTING PRESSURIZED GAS USING A JACKETED PIPE ANNULAR ASSEMBLY

(71) Applicant: HeH Storage Solutions LLC, Centennial, CO (US)

(72) Inventors: Tor Anders Vestad, Arvada, CO (US); Matthew Thomas Halker, Centennial, CO (US); Stephen Scott Gutberlet, Evergreen, CO (US); Andrew Ray Depperschmidt, Centennial, CO (US)

(21) Appl. No.: 18/612,721

(22) Filed: Mar. 21, 2024

Related U.S. Application Data
(60) Provisional application No. 63/491,419, filed on Mar. 21, 2023.

(51) Int. Cl. B01D 53/04; F16L 55/165

(52) U.S. Cl. CPC B01D 53/0446; F16L 55/1652; B01D 2257/108

(57) ABSTRACT

Systems, methods, and apparatus are provided for using a sweep gas to collect and recover leaked gas. In some embodiments, Helium or Hydrogen is stored in an inner conduit. As light Helium or Hydrogen leaks through the inner conduit, a sweep gas flows through an annular space between the inner conduit and an outer conduit to collect the Helium or Hydrogen. Then, the Helium or Hydrogen is separated from the rest of the sweep gas where the Helium or Hydrogen can be stored again or distributed and sold. In other embodiments, the annular space is between a liner and a steel pipe, and a sweep gas through the annular space protects the steel pipe from Hydrogen that leaks from the liner into the annular space. The embodiments described herein greatly lower the cost for storing or transporting gas such as Helium or Hydrogen at a much higher volume scale.

### CROSS-REFERENCE TO RELATED APPLICATIONS

This application claims priority under 35 U.S.C. § 119(e) to U.S. Provisional Patent Application Ser. No. 63/491,419 filed Mar. 21, 2023, which is incorporated herein in its entirety by reference.

### FIELD

The present disclosure relates generally to systems for storing or transporting a pressurized gas, such as Helium or Hydrogen, using a jacketed pipe assembly.

### BACKGROUND

The pressurized storage and transportation of gases such as Helium and Hydrogen in conventional metal tanks and pipes has many shortcomings due to the small molecular size of the gas, which increases the permeability of the molecules through the walls, connections, or other leak points of the storage tank or pipes. Prior art storage systems utilize exotic metals, alloys, or coatings to reduce the permeability of gasses through walls, connections, or other leak points of the tank or pipes. However, such materials significantly increase costs and often still do not adequately prevent the loss of the extremely small Helium and Hydrogen molecules from within the storage system. This is especially true when Helium and Hydrogen are stored at high concentrations and pressures to increase the density and standardized measured volume of the stored gas.

Additionally, while Helium is benign to most materials, Hydrogen causes dangerous stress cracking in carbon steel pipes at elevated partial pressures. Moreover, Hydrogen leaks can be dangerous due to the high range of potentially explosive mixtures of Hydrogen and air. As a result, pipeline transportation of Hydrogen is limited by a material incompatibility of Hydrogen with carbon steel pipe at elevated partial pressures, and thus, high pressure transportation of Hydrogen through the extensive network of existing pipelines is not safe or practical.

### SUMMARY

Embodiments of the present disclosure provide a system for storing or transporting a pressurized gas (Fluid A) in a multi-layered jacketed pipe assembly that comprises an inner volume and an annular outer volume. The pressurized gas (Fluid A) is stored or transported in the inner volume, and a carrier gas (Fluid B) forms part of a “sweep” gas that travels through the annular outer volume to capture and remove gas (Fluid A) that has leaked or diffused from the inner volume to the annular outer volume. The gas (Fluid A) can be subsequently separated from the rest of the sweep gas and processed for further storage, distribution, sales, etc. Embodiments of the present disclosure solve technical and commercial problems faced in various industries with cost-effective, long-term, and scalable systems for the storage or transportation of pressurized volumes of Hydrogen or Helium. While embodiments of the system are described with respect to a gas, it will be appreciated that embodiments of the present disclosure encompass and are applicable to fluids in any state, including gas or liquid.

It is an aspect of embodiments of the present disclosure to provide a multi-layered storage system with an inner volume and an annular outer volume to reduce the leakage of the pressurized, desired gas out of the system and into the environment. In some embodiments, the desired gas is Helium or Hydrogen, which is initially stored in the inner volume. Over time, the gas leaks into the annular outer volume. A sweep gas flows through the annular outer volume and carries away gas that leaks from the inner volume to maintain a low partial pressure of the desired gas in the annular outer volume. The low partial pressure in the annular outer volume reduces the leak rate out of the system to the environment to reduce the losses of valuable gases like Helium or Hydrogen and to protect other parts of the system from the Helium or Hydrogen.

The system can be made of pipes within pipes to define the inner and outer volumes, and the system can be utilized for storage or short and long-distance pipeline transportation systems. The sweep gas may comprise a carrier gas (Fluid B) and an amount of another desired gas (Fluid A) that has leaked from the inner volume, and the sweep gas directs the desired gas out of the annular outer volume before the partial pressure of the desired gas reaches a predetermined or unsafe threshold. The term “sweep gas” can be broadly construed to include any gas or fluid used to sweep and capture molecules escaping from the inner storage or transportation pipe into the annular outer volume. Moreover, the terms “desired gas” and “product gas” may be used interchangeably with each other and/or Helium or Hydrogen or any other fluid that can benefit from storage in embodiments of the present disclosure. In some embodiments, when the desired gas or product gas is Helium or Hydrogen, then a wide range of gasses can be used as a carrier gas in a sweep gas stream. Helium and Hydrogen molecules are small and while Hydrogen can be reactive in some instances, Helium is inert. Thus, natural gas (mostly methane), CO₂, N₂, etc. can all be used as a carrier gas (Fluid B) in a sweep gas stream.

In various embodiments, there are several potential destinations for the sweep gas flowing through the annular outer volume. The first potential destination for the sweep gas is a separation unit that separates the desired gas from the carrier gas to recycle the desired gas. Once the desired gas is separated from the carrier gas, the desired gas may be returned to the inner volume for storage or transportation, the desired gas can be distributed and sold, or the desired gas can be sent to another location for some other beneficial use. The separated carrier gas can then be reused in the sweep gas or sent to another location for some other beneficial use. In one example, a system stores Helium produced with natural gas from a well, and a separation unit separates the Helium from the natural gas in the well fluid. In another example, a system stores Hydrogen produced in a Steam Methane Reformer (SMR) unit followed by a Water Gas Shift (WGS) and solvent based or Pressure Swing Absorption (PSA) based CO₂ separation unit. In yet a further example, a dedicated solvent separation unit is used in conjunction with a standalone Hydrogen or Helium storage system.

The second potential destination for the sweep gas comprising the carrier gas and desired gas that has leaked from the inner volume to the outer volume is a destination that can make use of the combined sweep gas stream without separation. As an example, if natural gas is used as a carrier gas for Hydrogen storage, then the sweep gas is compatible with conventional carbon steel pipe due to a sufficiently low partial pressure of Hydrogen, which is the absolute total pressure of the system multiplied by the molar fraction of Hydrogen in the gas. High partial pressures of Hydrogen gas are not compatible with carbon steel pipes due to a tendency to produce cracks in the metal leading to catastrophic failure of the pipe systems. However, a specified fraction of Hydrogen is generally allowable in natural gas sales specifications that keeps the partial pressure of Hydrogen low enough to avoid cracking conventional carbon steel pipes. As a result, the combined sweep gas comprising the leaked Hydrogen and the natural gas can be sold as the natural gas product without separation, as long as the sweep gas rate is high enough to keep the Hydrogen composition below the sales specification of the combined stream.

It is another aspect of embodiments of the present disclosure to provide a system to protect, for example, a carbon steel pipe from Hydrogen while transporting the Hydrogen at high partial pressure (>75 psia) using a jacketed pipe assembly. Embodiments of the present disclosure address technical and commercial problems long faced by the rapidly expanding Hydrogen industry for the cost-effective, long-distance transportation of pressurized Hydrogen in pipelines constructed of materials such as carbon steel. In some embodiments, a liner is positioned in a carbon steel pipe, and Hydrogen flows through an inner volume of the liner. In addition, a sweep gas flows through an annular outer volume defined between the liner and the carbon steel pipe. The sweep gas flows through the annular outer volume to remove Hydrogen molecules that leak from the inner volume to the annular outer volume and that would otherwise contact the carbon steel pipe before the partial pressure of the Hydrogen in the annular outer volume becomes high enough to damage the carbon steel pipe. The transportation system comprises the Hydrogen stream under pressure within the liner of the jacketed pipe assembly and comprises a second stream with a different gas that is compatible with carbon steel pipe and may be separated from the Hydrogen in a processing/separation unit or used in a mixture with the leaked Hydrogen (such as natural gas or CO₂). This combination of gasses flows through the annular outer volume between the liner and carbon steel pipe to capture and “sweep” any Hydrogen leaking or diffusing through the inner liner.

As described herein, the sweep gas including any leakage are then either conveyed to a process/separation unit to separate the Hydrogen from the sweep gas, or sent to a different destination without separation, such as a combination of natural gas sweep gas and Hydrogen that is used as fuel. If the Hydrogen is separated from the sweep gas, the Hydrogen can be returned to the inner volume within the liner, and the sweep gas may be recycled to the annular outer volume to be reused as sweep gas again or sent to another location. Embodiments of the present disclosure are highly scalable in whatever volumes are needed and is applicable in any operating or weather conditions that may be experienced. Embodiments of the present disclosure can be applied to either newly constructed pipelines, or by pushing a liner into existing carbon steel pipelines, which can be retrofitted to carry pressurized Hydrogen gas instead of natural gas.

Embodiments of the present disclosure encompass many arrangements of inner and outer containment structures that define the inner and outer volumes. This includes any inner pressurized volume surrounded, wholly or partially, by an outer volume where the sweep gas circulates to an associated separation unit for recovery of the leaked gas (Fluid A), or the combined gas flows to another location for a beneficial purpose. This arrangement is also applicable to long runs of concentric pipes that define the inner and outer containment structures.

For example, when the desired gas is Helium, a heavy wall carbon steel inner pipe containing a high pressure storage volume with a low pressure outer pipe potentially made of steel or polymer is economically viable due to the compatibility of Helium with conventional carbon steel. Thus, the Helium can be stored at high pressure in a reduced volume of the inner pipe while the outer volume can operate at a low pressure, and therefore the larger, outer pipe can be thinner walled.

For systems containing high pressure Hydrogen, an inner liner of polymer pipe surrounded by a pressurized outer volume requires a larger volume to operate at high pressure. Thus, the outer pipe may have thicker steel walls, but by putting the low cost, high strength steel on the outside, the partial pressure of Hydrogen in contact with the steel can be controlled so that existing and low cost pipelines can be used. The optional addition of helical ridges extending from an outer surface of the liner encourages the sweep gas to flow around the entire liner to avoid creating pockets of stagnant gas in the annular outer volume. Moreover, the ridges can protect the liner from rubbing against the rough outer pipe and protect the liner from being damaged, and the ridges can also help centralize the liner relative to the outer pipe. It will be appreciated that the present disclosure encompasses embodiments of the liner that have at least one ridge that has either a helical arrangement or another arrangement.

A first aspect of the present disclosure is to provide a system for capturing a product gas using a sweep gas, comprising an inner conduit having an inner volume, wherein the inner conduit is configured to store the product gas within the inner volume; an outer conduit positioned around the inner conduit to define an annular volume between the inner and outer conduits, wherein the inner and outer conduits are configured to transport the sweep gas through the annular volume to collect product gas that has leaked from the inner volume to the annular volume; a separation unit configured to receive the sweep gas from the annular volume and configured to separate the product gas from the sweep gas, wherein the inner and outer conduits are configured to receive the sweep gas from the separation unit through the annular volume; and a compressor configured to pressurize at least one of the product gas from the inner volume of the inner conduit or the product gas from the separation unit to an output pressure for sales and distribution.

In a system of the first aspect, optionally, the product gas is one of Helium or Hydrogen.

The system of the first aspect may include one or more of the previous embodiments and, optionally, the sweep gas comprises at least one of natural gas, carbon dioxide, or nitrogen.

The system of the first aspect may include one or more of the previous embodiments and, optionally, further comprise a gas well configured to add more product gas to the sweep gas at a location upstream of the separation unit.

The system of the first aspect may include one or more of the previous embodiments and, optionally, further comprise one or more of a first compressor located upstream of the annular volume and configured to increase a pressure of the sweep gas downstream from the separation unit; and a second compressor located downstream of the annular volume and configured to increase the pressure of the sweep gas upstream of the separation unit.

The system of the first aspect may include one or more of the previous embodiments and, optionally, further comprise a flow controller configured to detect a flow rate of the product gas for sales and distribution, and the flow controller is configured to control the flow rate with a valve.

The system of the first aspect may include one or more of the previous embodiments and, optionally, further comprise a pressure controller configured to detect a pressure of the sweep gas upstream of the annular volume, and the pressure controller is configured to control the pressure with a valve.

The system of the first aspect may include one or more of the previous embodiments and, optionally, further comprise a first valve located upstream of the inner volume of the inner conduit; and a second valve located downstream of the inner volume of the inner conduit, wherein the first and second valves are configured to control the flow of product gas into and out of the inner volume of the inner conduit.

The system of the first aspect may include one or more of the previous embodiments and, optionally, the inner conduit has a first thickness and the outer conduit has a second thickness that is less than the first thickness.

The system of the first aspect may include one or more of the previous embodiments and, optionally, the inner conduit comprises a first material and the outer conduit comprises a second material that is different than the first material.

A second aspect of the present disclosure is to provide a system for transporting a Hydrogen gas, comprising a liner having an inner volume, wherein the liner is configured to transport the Hydrogen gas through the inner volume; a carbon steel pipe positioned around the liner to define an annular volume between the liner and the carbon steel pipe, wherein the liner and the carbon steel pipe are configured to transport a sweep gas through the annular volume to collect Hydrogen gas that has leaked from the inner volume to the annular volume and configured to maintain a partial pressure of the Hydrogen gas in the annular volume below a predetermined threshold to prevent damage to the carbon steel pipe.

In a system of the second aspect, optionally, the liner comprises at least one of a high density polyethylene pipe, a reinforced thermoplastic pipe, a polyethylene pipe, or a chlorinated polyvinyl chloride pipe.

The system of the second aspect may include one or more of the previous embodiments and, optionally, the liner comprises at least one ridge extending into the annular volume to direct the flow of the sweep gas through the annular volume.

The system of the second aspect may include one or more of the previous embodiments and, optionally, first and second ends of the liner each comprise a flange that extends outward in a radial direction by a same distance as a flange on each of the first and second ends of the carbon steel pipe, and wherein a gasket is positioned between the flange of the liner and the flange of the carbon steel pipe, at each of the ends of the liner and carbon steel pipe.

A third aspect of the present disclosure is to provide a method for storing a product gas using a sweep gas, comprising providing an inner conduit within an outer conduit to define an annular volume between the inner conduit and the outer conduit, wherein the inner conduit defines an inner volume; transporting the product gas to the inner volume of the inner conduit, wherein the product gas is stored within the inner volume; circulating the sweep gas through the annular volume to collect product gas that has leaked from the inner volume to the annular volume; separating, by a separation unit, the product gas from the sweep gas; and supplying at least one of the product gas from the inner volume or the product gas from the separation unit at an output pressure for sales and distribution.

The system of the third aspect may, optionally, further comprise maintaining, by a pressure controller, a pressure of the sweep gas in the annular volume at between approximately 10 to 50 psig.

The system of the third aspect may include one or more of the previous embodiments and, optionally, further comprise maintaining, by a flow controller, a predetermined volume of sweep gas in the annular volume such that a partial pressure of the product gas in the annular volume is less than or equal to 1 psi.

The system of the third aspect may include one or more of the previous embodiments and, optionally, further comprise storing the product gas in the inner volume using a first valve located upstream of the inner volume and a second valve located downstream of the inner volume.

The system of the third aspect may include one or more of the previous embodiments and, optionally, further comprise retrieving the product gas from the inner volume of the inner conduit by opening at least one of the first valve or the second valve.

The system of the third aspect may include one or more of the previous embodiments and, optionally, further comprise pressurizing, by a compressor, at least one of the separated product gas or the retrieved product gas at the output pressure for sales and distribution.

A fourth aspect of the present disclosure is to provide a system for capturing a Hydrogen gas using a sweep gas, comprising a liner having an inner volume that extends between an input end and an output end, wherein the liner is configured to transport the Hydrogen gas through the inner volume; a carbon steel pipe positioned around the liner to define an annular volume between the liner and the carbon steel pipe, wherein the annular volume extends between an input end and an output end, and wherein the liner and the carbon steel pipe are configured to transport a sweep gas through the annular volume; a first pressure controller configured to detect a pressure of the Hydrogen gas upstream of the inner volume, and the first pressure controller is configured to control the pressure of the Hydrogen gas at the input end of the inner volume with a first valve; and a second pressure controller configured to detect a pressure of the sweep gas downstream of the annular volume, and the second pressure controller is configured to control the pressure of the sweep gas at the output end of the annular volume with a second valve.

In a system of the fourth aspect, optionally, the liner comprises at least one of a high density polyethylene pipe, a reinforced thermoplastic pipe, a polyethylene pipe, or a chlorinated polyvinyl chloride pipe.

The system of the fourth aspect may include one or more of the previous embodiments and, optionally, that the liner comprises at least one ridge extending into the annular volume to direct the flow of the sweep gas through the annular volume.

The system of the fourth aspect may include one or more of the previous embodiments and, optionally, a flow controller configured to detect a flowrate of the sweep gas upstream of the annular volume, and the flow controller is configured to control the flowrate of the sweep gas with a third valve; and a gas composition analyzer configured to sample a Hydrogen concentration in the sweep gas downstream of the annular volume, wherein, if the gas composition analyzer detects a Hydrogen concentration above a predetermined value, the flow controller increases the flow rate of the sweep gas within the annular volume.

The system of the fourth aspect may include one or more of the previous embodiments and, optionally, that the sweep gas comprises at least one of natural gas, carbon dioxide, or nitrogen.

The system of the fourth aspect may include one or more of the previous embodiments and, optionally, that the first pressure controller sets the pressure of the Hydrogen gas at the input end of the inner volume to a value less than a Maximum Allowable Operating Pressure (MAOP) of the carbon steel pipe.

The system of the fourth aspect may include one or more of the previous embodiments and, optionally, that a line is attached to the liner, the line having a higher tensile strength than the liner.

The system of the fourth aspect may include one or more of the previous embodiments and, optionally, a flow controller configured to detect a flowrate of the Hydrogen gas downstream of the inner volume, and the flow controller is configured to control the flowrate of the Hydrogen gas with a fourth valve.

A fifth aspect of the present disclosure is to provide a method for deploying an inner liner within a carbon steel pipe, comprising providing a line on the inner liner, the line having a higher tensile strength than the inner liner; drawing the line and the inner liner through the carbon steel pipe until the inner liner is substantially positioned within the carbon steel pipe; defining a liner volume within the inner liner, wherein the liner volume is configured to transport a Hydrogen gas; and defining an annular volume between the inner liner and the carbon steel pipe, wherein the annular volume is configured to transport a sweep gas to collect Hydrogen gas that leaks through the inner liner and to protect the carbon steel pipe from Hydrogen gas.

The method of the fifth aspect may, optionally, further comprise introducing the Hydrogen gas into an input end of the liner volume at a first pressure; and introducing the sweep gas into an input end of the annular volume at a second pressure, wherein the input end of the annular volume is proximate to the input end of the liner volume, and wherein the first and second pressures are approximately equal.

The method of the fifth aspect may include one or more of the previous embodiments and, optionally, that the first and second pressure are within +/−5% of each other on a relative basis.

The method of the fifth aspect may include one or more of the previous embodiments and, optionally, that the inner liner has an abrasion layer on an outer surface of the inner liner.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

The term “a” or “an” entity, as used herein, refers to one or more of that entity. As such, the terms “a” (or “an”), “one or more” and “at least one” can be used interchangeably herein.

Unless otherwise indicated, all numbers expressing quantities, dimensions, conditions, ratios, ranges, and so forth used in the specification and claims are to be understood as being modified in all instances by the term “about” or “approximately”. Accordingly, unless otherwise indicated, all numbers expressing quantities, dimensions, conditions, ratios, angles, ranges, and so forth used in the specification and claims may be increased or decreased by approximately 5% to achieve satisfactory results. Additionally, where the meaning of the terms “about” or “approximately” as used herein would not otherwise be apparent to one of ordinary skill in the art, the terms “about” and “approximately” should be interpreted as meaning within plus or minus 10% of the stated value.

Unless otherwise indicated, the term “substantially” indicates a different of from 0% to 5% of the stated value is acceptable.

All ranges described herein may be reduced to any sub-range or portion of the range, or to any value within the range without deviating from the disclosure. For example, the range “5 to 55” includes, but is not limited to, the sub-ranges “5 to 20” as well as “17 to 54.”

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials, or acts and the equivalents thereof shall include all those described in the Summary, Brief Description of the Drawings, Detailed Description, Abstract, and Claims themselves.

### BRIEF DESCRIPTION OF THE DRAWINGS

The accompanying drawings, which are incorporated in and constitute a part of the specification, illustrate embodiments of the disclosed system and together with the general description of the disclosure given above and the detailed description of the drawings given below, serve to explain the principles of the disclosed system(s) and device(s).

FIG. 1 is a block diagram of a storage system used to separate and store Helium produced by a well in association with natural gas according to an embodiment of the present disclosure.

FIG. 2 is a perspective view of a jacketed pipe assembly according to an embodiment of the present disclosure.

FIG. 3 is a cross-sectional elevation view of a pipe with an inner liner connected to a Hydrogen source and to a destination according to an embodiment of the present disclosure.

FIG. 4 is a block diagram of a storage system used to separate and store Hydrogen produced by a Steam Methane Reformer (SMR) unit with a Water Gas Shift (WGS) and solvent based or Pressure Swing Absorption (PSA) separation unit according to an embodiment of the present disclosure.

FIG. 5 is a block diagram of a transportation system used to transport Hydrogen or Helium (Fluid A) from an external source to a desirable destination using a dedicated sweep gas loop comprising carbon dioxide and an amine solvent system for separation of the desired gas from the sweep gas for recycling according to an embodiment of the present disclosure.

FIG. 6 is a block flow diagram of a transportation system used to transport Hydrogen with a natural gas sweep gas with the sweep gas going to natural gas sales as fuel according to an embodiment of the present disclosure.

FIG. 7 is a block diagram of a storage system used to store Hydrogen or Helium from an external source using a dedicated sweep gas loop comprising carbon dioxide and an amine solvent system for separation of the desired gas from the sweep gas for recycling according to an embodiment of the present disclosure.

FIG. 8 is a cross-sectional elevation view of a connection of an inner and outer pipe of a jacketed pipe assembly such that high partial pressures of Hydrogen gas are not exposed to the outer pipe according to an embodiment of the present disclosure.

FIG. 9 is a block diagram of a storage system according to an embodiment of the present disclosure.

FIG. 10 is a block diagram of a transportation system according to an embodiment of the present disclosure.

FIG. 11 is a schematic view of a control device for operating a storage system or transportation system according to an embodiment of the present disclosure.

FIG. 12A is a cross-sectional elevation view of a liner deployed in a first position within an outer pipe according to an embodiment of the present disclosure.

FIG. 12B is a cross-sectional elevation view of a liner deployed in a second position within an outer pipe according to an embodiment of the present disclosure.

FIG. 13 is a flowchart for a process of deploying an inner liner within an outer pipe according to an embodiment of the present disclosure.

FIG. 14 is a block diagram of a transportation system according to an embodiment of the present disclosure.

The drawings are not necessarily (but may be) to scale. In certain instances, details that are not necessary for an understanding of the disclosure or that render other details difficult to perceive may have been omitted. It should be understood, of course, that the disclosure is not necessarily limited to the embodiments illustrated herein. As will be appreciated, other embodiments are possible using, alone or in combination, one or more of the features set forth above or described below. For example, it is contemplated that various features and devices shown and/or described with respect to one embodiment may be combined with or substituted for features or devices of other embodiments regardless of whether or not such a combination or substitution is specifically shown or described herein.

The following is a listing of components according to various embodiments of the present disclosure, and as shown in the drawings:

| Number | Component |
|---|---|
| 110 | Well |
| 115 | Input Stream |
| 120 | Separation Unit |
| 122 | First Output Stream (Helium Product) |
| 124 | Second Output Stream (Non-Helium Product) |
| 130 | Helium Product Compressor |
| 140 | Jacketed Pipe Assembly |
| 150 | First Valve |
| 152 | Second Valve |
| 160 | Helium Sales Output Stream |
| 170 | Sweep Gas Compressor |
| 174 | Sweep Gas Stream |
| 180 | Return Gas Stream |
| 240 | Storage Gas Entrance/Exit |
| 242 | Inner Pipe |
| 243 | Joints (welds, fittings, pipe walls, etc.) |
| 244 | Outer Pipe |
| 246 | Annular Outer Volume |
| 247 | Sweep Gas Entrance |
| 248 | Sweep Gas Exit |
| 338 | Carbon Steel Pipe |
| 340 | Liner |
| 346 | Sweep Gas Input |
| 348 | Sweep Gas Output |
| 350 | Hydrogen Source Valve |
| 352 | Hydrogen Destination Valve |
| 354 | Flange |
| 356 | Flange |
| 358 | Boundary (Pipe Length) |
| 360 | Helical Ridge |
| 412 | Steam Methane Reformer |
| 416 | Input Stream (Crude Syngas Gas) |
| 420 | Separation Unit |
| 422 | First Output Stream (Hydrogen Product) |
| 424 | Second Output Stream (Non-Hydrogen Product) |
| 430 | Hydrogen Product Compressor |
| 440 | Jacketed Pipe Assembly |
| 450 | First Valve |
| 452 | Second Valve |
| 460 | Sales Output Stream |
| 470 | Compressor |
| 474 | Sweep Gas Stream |
| 480 | Return Gas Stream |
| 510 | External Source Stream |
| 515 | Sales Input Stream |
| 520 | Recycled Hydrogen or Helium |
| 530 | Compressor |
| 540 | Sweep Gas Stream |
| 545 | Separation Unit |
| 550 | Jacketed Pipe Assembly |
| 560 | Sales Output Stream |
| 570 | Compressor |
| 574 | Sweep Gas Input |
| 580 | Sweep Gas Return |
| 610 | Hydrogen Gas Input |
| 630 | Compressor |
| 640 | Jacketed Pipe Assembly |
| 650 | Natural Gas Input |
| 660 | Hydrogen Output Stream |
| 670 | Hydrogen/Natural Gas Output Stream |
| 720 | Separation Unit |
| 722 | Purified Gas Stream |
| 730 | Compressor |
| 740 | Jacketed Pipe |
| 747 | Sweep Gas Input Stream |
| 748 | Sweep Gas Return Stream |
| 770 | Compressor |
| 790 | Input/Output Stream |
| 810 | Outer Pipe |
| 812 | Valve |
| 814 | Liner |
| 816 | Flange (Outer Pipe) |
| 818 | Flange (Valve) |
| 820 | Flange (Liner) |
| 822 | Bolt |
| 824 | Sweep Gas Inlet |
| 826 | Gaskets |
| 910 | Gas Well |
| 912 | Acid Gas Removal Unit |
| 914 | Acid Gas Disposal Stream |
| 916 | Recycle Sweep Gas |
| 918 | Sweet Gas Stream |
| 920 | Nitrogen Rejection Unit |
| 922 | Vent Stream (Nitrogen) |
| 924 | Natural Gas Stream |
| 926 | Helium Gas Stream |
| 928 | Helium Purification Unit |
| 930 | Helium Product |
| 932 | Retrieved Helium |
| 934 | Compressor |
| 936 | Flow Controller |
| 938 | Valve |
| 940 | Sales Output Stream |
| 942 | Pressure Controller |
| 944 | Valve |
| 946 | Valve |
| 948 | Natural Gas Sales |
| 950 | Valve |
| 952 | Pressure Controller |
| 954 | Jacketed Pipe Assembly |
| 956 | Inner Pipe |
| 958 | Outer Pipe |
| 960 | Diffusion |
| 962 | Sweep Gas |
| 964 | Flow Controller |
| 966 | Gas Composition Analyzer |
| 968 | Compressor |
| 1010 | Hydrogen Source |
| 1012 | Valve |
| 1014 | Pressure Controller |
| 1016 | Natural Gas Source |
| 1018 | Valve |
| 1020 | Pressure Controller |
| 1022 | Jacketed Pipe Assembly |
| 1024 | Liner |
| 1026 | Outer Pipe |
| 1028 | Diffusion |
| 1030 | Sweep Gas |
| 1032 | Flow Controller |
| 1034 | Gas Composition Analyzer |
| 1036 | Valve |
| 1038 | Natural Gas Sales |
| 1040 | Valve |
| 1042 | Flow Controller |
| 1044 | Hydrogen Sales Output |
| 1110 | Control Device |
| 1112 | Pressure Sensor |
| 1114 | Flow Sensor |
| 1116 | Composition Sensor |
| 1118 | Valve |
| 1210 | Jacketed Pipe |
| 1212 | Inner Liner |
| 1214 | Liner Volume |
| 1216 | Outer Pipe |
| 1218 | Annular Volume |
| 1220 | Line |
| 1310 | Process for Deploying Liner |
| 1312 | Attach Line |
| 1314 | Pull Line and Inner Liner |
| 1316 | Define Liner Volume and Annular Volume |
| 1318 | Transmit First and Second Fluids |
| 1410 | Hydrogen Source |
| 1412 | Valve |
| 1414 | Pressure Controller |
| 1416 | Sweep Gas Source |
| 1418 | Valve |
| 1420 | Flow Controller |
| 1422 | Jacketed Pipe Assembly |
| 1424 | Inner Liner |
| 1425 | Liner Volume |
| 1426 | Outer Pipe |
| 1427 | Annular Volume |
| 1428 | Diffusion |
| 1429a | Input End (Liner Volume) |
| 1429b | Output End (Liner Volume) |
| 1430 | Sweep Gas |
| 1431a | Input End (Annular Volume) |
| 1431b | Output End (Annular Volume) |
| 1432 | Pressure Controller |
| 1434 | Gas Composition Analyzer |
| 1436 | Valve |
| 1438 | Sweep Gas Sales |
| 1440 | Valve |
| 1442 | Flow Controller |
| 1444 | Hydrogen Sales Output |

### DETAILED DESCRIPTION

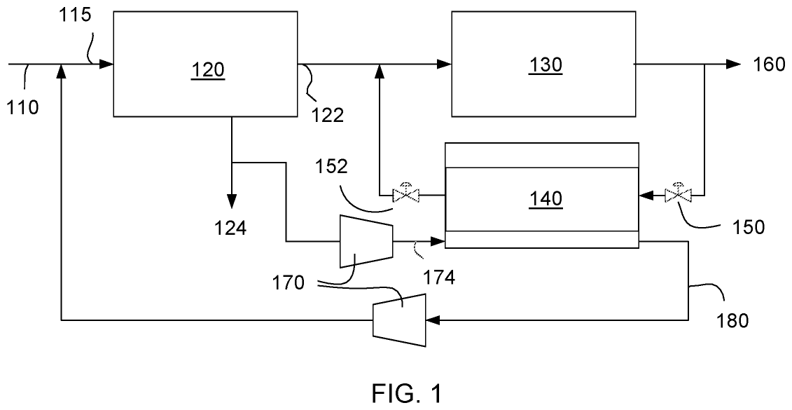

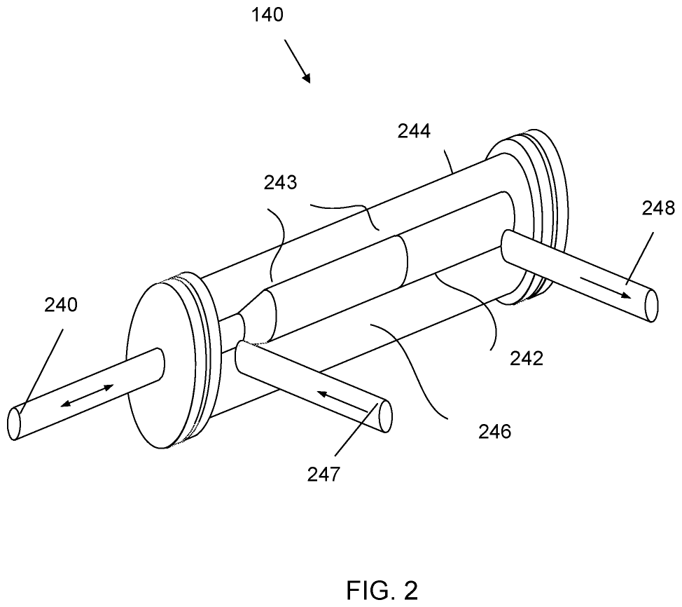

FIG. 1 is a block diagram showing a storage system used to separate and store Helium (Fluid A in this embodiment) produced by a well (110) in combination with natural gas (Fluid B in this embodiment) and other components. FIG. 2 shows a perspective view of a jacketed pipe assembly (140) of the storage system in FIG. 1.

The input stream (115) containing both natural gas and Helium is initially processed by a separation unit (120) to produce a first output stream (122) containing concentrated Helium, and a second output stream (124) containing natural gas and the remaining constituents of the input stream (115). The separation unit (120) can use many different processes to recover Helium from methane and other gaseous streams such as CO₂ and N₂, including cryogenic processes, or zeolite, or polymeric or metal organic framework (MOF) membranes, or pressure-swing adsorption or solvent processes.

The recovered, first output stream (122) can be pressurized by a compressor (130) for storage in the inner pipe (242) of the jacketed pipe assembly (140). FIG. 1 shows valves (150 and 152) at the ends of the inner pipe (242) that control the flow of Helium into and out of the inner pipe (242). The valves (150 and 152) can be selectively actuated to either allow a flow of Helium into the inner pipe (242) for storage or allow a sales output stream (160) of Helium to be dispensed from storage in the inner pipe (242). In this sense, part of the storage system in FIG. 1 forms a Helium gas loop from the compressor (130) to the jacketed pipe assembly (140), back to the compressor (130), etc. The jacketed pipe assembly (140) can be arranged such that Helium flows in a single direction through the inner pipe (242) or Helium flows in and out of the inner pipe (242) through a single entrance/exit (240). Thus, the Helium gas loop can also incorporate a conduit or a pipe where Helium or other product gas can flow in multiple directions.

The inner pipe (242) is surrounded by an outer pipe (244) that serves as a containment jacket, and an annular outer volume (246) is defined between the inner pipe (242) and the outer pipe (244). In some embodiments, centralizers help maintain the position of the inner pipe (242) such that exterior surfaces of the inner pipe are spaced from interior surfaces of the outer pipe. The centralizers may optionally maintain the inner pipe approximately at the center of the outer pipe (244). A sweep gas flows into the sweep gas entrance (247), through the annular outer volume (246), and out of the sweep gas exit (248) as shown in FIG. 2. The ends of the annular outer volume (246) are sealed to define an enclosed region surrounding the inner pipe (242) so that Helium permeating through the wall of the inner pipe (242) is contained within the outer pipe (244) and collected by the sweep gas.

Specifically, as shown in FIG. 1, a portion of the second output stream (124) (e.g., natural gas, or carbon dioxide or nitrogen or any combination thereof) from the separation unit (120) enters the jacketed pipe assembly (140) and flows through the annular outer volume (246) of the jacketed pipe assembly (140) to serve as a sweep gas stream (174/247). Any Helium escaping from the inner pipe (242) into the annular outer volume (246) is entrained by the sweep gas stream (174/247). For example, welds or fittings (243) on the inner pipe (242) are common leak points as shown in FIG. 2.

A compressor (170) propels the flow of the sweep gas stream (174/247) through the annular outer volume (246). Specifically, the compressor (170) increases the pressure of the sweep gas to create a differential pressure (“Delta P”) within the sweep gas stream (174/247) to propel the sweep gas through the annular outer volume (246) and collect Helium that leaks from the inner pipe (242) to the annular outer volume (246) and to propel the sweep gas to other components such as a separation unit (120). The compressor (170) may be located either upstream and/or downstream of the jacketed pipe assembly (140). Optionally, as depicted in FIG. 1, the storage system comprises two compressors (170), with a first compressor located upstream of the jacketed pipe assembly (140) and a second compressor located downstream of the jacketed pipe assembly (140). Examples of a compressor (170) can include, but are not limited to, a rotary lobe pump, a rotary screw compressor, a liquid ring compressor, a scroll compressor, a sliding vane compressor, a diaphragm compressor, a double acting compressor, a single acting compressor, a centrifugal compressor, and an axial compressor.

The sweep gas stream (174/247) and any captured Helium from the annular outer volume (246) flow via a return stream (180/248) to join the input stream (115) to the separation unit (120) for reprocessing. The sweep gas stream (180) returning to the separation unit (120) has lowered the partial pressure of the leaking gas which lowers the rate of potential leaks of Helium from the annular outer volume (246) to the environment. In this sense, part of the storage system forms a sweep gas loop from the separation unit (120), through the annular outer volume (246), back to the separation unit (120), etc.

The embodiments described herein can be readily adapted for storage of other pressurized gases within an inner pipe (242) of a jacketed pipe assembly (140). It should also be understood that the jacketed pipe assembly (140) does not necessarily require pipes (242 and 244) with circular cross-sections, as shown in FIG. 2. Pipes with circular cross-sections offer an advantage of minimizing the wall surface area. However, for example, these pipes (242 and 244) can have oval or rectangular cross-sections. Then, the volume between the inner and outer pipes (242 and 244) does not have a circular, annular in shape but still allows a flow of sweep gas between the inner and outer pipes (242 and 244). Thus, the annular outer volume (246) in the embodiments of the present disclosure encompass any intermediate region between the inner and outer pipes (242 and 244), or any two pipes or structures, that allows a flow of sweep gas, which may be returned to an associated processing/separation unit (120). In addition, the jacketed pipe assembly (140) can be constructed with more than two nested or concentric pipes, so that more than one annular outer volume exists between the pipes within the jacketed pipe assembly (140). Alternatively, multiple inner pipes can be placed within a single outer pipe. All of these variations should be considered as falling within the scope of the present disclosure.

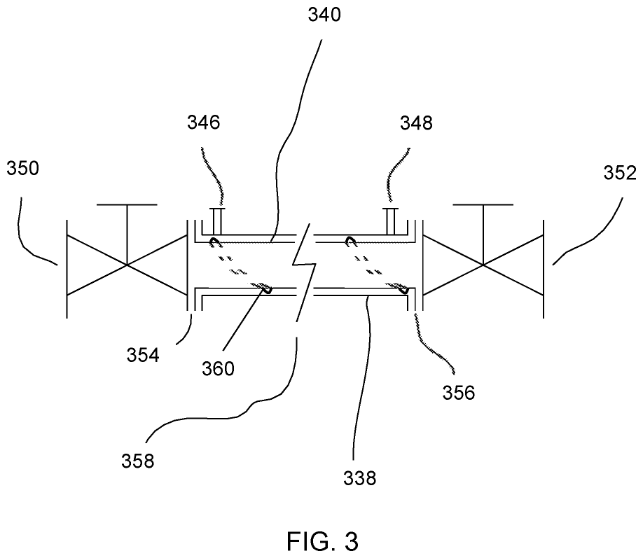

FIG. 3 is a cross-sectional elevation view of a carbon steel pipe (338) with an inner liner (340) connected to a Hydrogen source and destination to protect the carbon steel pipe (338) from Hydrogen exposure. One end of the carbon steel pipe (338) and liner (340) has a flange (354) that is connected to the Hydrogen source via valve (350), and an opposing end of the carbon steel pipe (338) and liner (340) has a flange (356) that is connected to the Hydrogen destination via a valve (352). The valves (350, 352) selectively control the flow of Hydrogen into and out of the carbon steel pipe (338) and liner (340). FIG. 3 shows a break line (358) at the center of the carbon steel pipe (338), indicating that the carbon steel pipe (338) can have any length.

The liner (340) is disposed within the carbon steel pipe (338) and an annular outer volume is defined between the liner (340) and the carbon steel pipe (338). Hydrogen is transported through the inner volume of the liner (340) but may leak or diffuse through the liner (340) or other components. A sweep gas flows through an entrance or sweep gas input (346) through the annular outer volume, and then out of an exit or sweep gas output (348). The sweep gas collects and carries away any leaked Hydrogen for further processing. The reduction in Hydrogen in the annular outer volume prevents too much Hydrogen from contacting the carbon steel pipe (338), which can cause damage to the carbon steel pipe (338).

The liner (340) may have one or more helical ridges (360) extending from an outer surface of the liner (340) to maintain separation of the liner (340) from the inner surface of the carbon steel pipe (338) and to limit potential dead spots where a lack of differential pressure (“Delta P”) exists and, therefore, where Hydrogen may concentrate in an undesirable manner. The helical ridges (360) as partially shown in phantom behind the inner pipe (340). The ridges can channel and/or perturb the flow of the sweep gas to limit dead spots. In some embodiments the helical ridges spiral around the outer surface of the liner from the first flange (354) to the second flange (356).

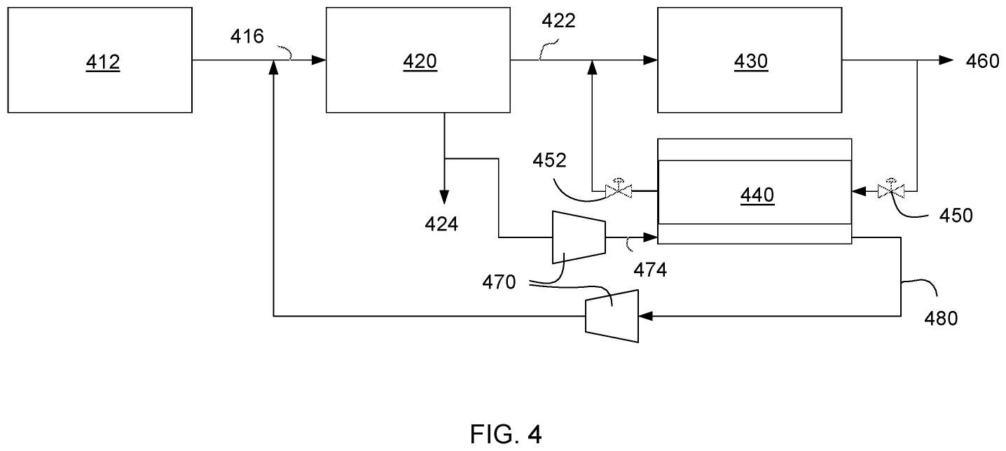

FIG. 4 is a block diagram of a storage system for storing Hydrogen (Fluid A in this embodiment) produced in a Steam Methane Reformer (SMR) (412) followed by a Water Gas Shift (WGS) reactor (420) and a H₂/CO₂ separation process for separation of carbon dioxide from the H₂ product stream. In this embodiment, the input stream (416) to the H₂/CO₂ separation unit (420) is a mixture of Hydrogen, carbon monoxide, and carbon dioxide output by the SMR (412). This input stream (416) may be referred to as a synthesis gas, or syngas. For example, natural gas and water can be reacted into Hydrogen, carbon monoxide, carbon dioxide and water at high temperatures using catalysts. The separation unit (420) can utilize a process (e.g., WGS followed by solvent carbon dioxide separation unit or PSA unit) that outputs a first product stream (422) containing purified Hydrogen and a second product stream (424) containing carbon dioxide (Fluid B in this embodiment). The first product stream (422) containing Hydrogen is pressurized by a compressor (430) for storage in the inner pipe (242, FIG. 2) of the jacketed pipe assembly (440) using valves (450 and 452) or for sales and distribution at an output sales stream (460). A portion of the second product stream (424) containing CO₂ serves as the sweep gas stream (474) to capture any product gas leaking from the inner pipe (242, FIG. 2) into the annular outer volume (246, FIG. 2) of the jacketed pipe assembly (440). The sweep gas, including any entrained Hydrogen, can be propelled with one or more compressors (470) and then returned in a return stream (480) to the input stream (416) and the separation unit (420) for reprocessing.

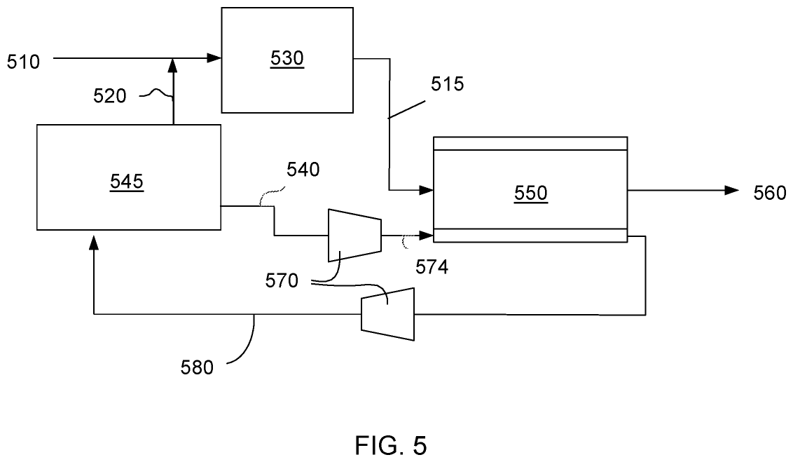

FIG. 5 is a block diagram of a transportation system that can transport Hydrogen or Helium (Fluid A in this embodiment) from an external source stream (510) that is not associated with the system to a destination (560). The Helium or Hydrogen product gas (515) serves as a sales input stream that is pressurized by a compressor (530) for transportation in the jacketed pipe assembly (550) or for subsequent sales and distribution in a sales output stream (560). The jacketed pipe assembly (550) includes the components of the jacket pipe assembly (140) described in conjunction with FIGS. 1 and 2.

A sweep gas that can include carbon dioxide (Fluid B in this embodiment) is propelled through a sweep gas loop stream (540/574/580) by one or more compressors (570). A dedicated separation unit (545) is provided that purifies the Helium or Hydrogen captured by the sweep gas so that recycled Helium or Hydrogen (520) may be returned to the jacketed pipe assembly (550), while also providing purified sweep gas to be recycled into the annular volume of the jacketed pipe assembly (550).

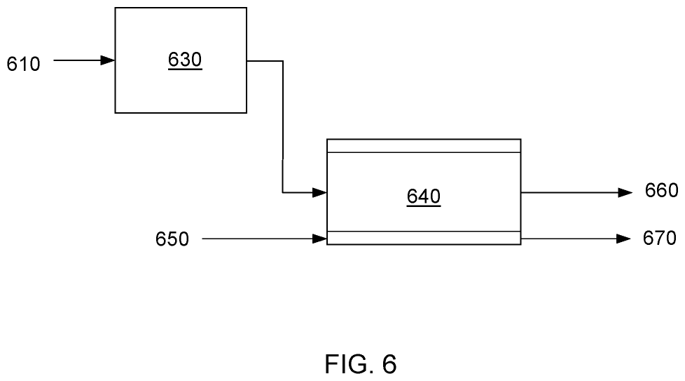

FIG. 6 is a block diagram of a system that can store or transport Hydrogen with a natural gas sweep gas. To begin, a gas input (610) provides a stream of Hydrogen (Fluid A in this embodiment), which is pressurized by a compressor (630) and stored or transported in a jacketed pipe assembly (640). The jacketed pipe assembly (640) includes some or all of the components of the jacketed pipe assembly (140) described in conjunction with FIGS. 1 and 2.

A natural gas (650) (Fluid B in this embodiment) that has less than the allowable Hydrogen concentration per the specification of the final purchaser of the natural gas stream forms at least part of a sweep gas through an annular outer volume of the jacketed pipe assembly (640). The natural gas sweep rate is high enough that the combined stream of Hydrogen that leaks into the annular outer volume and the natural gas has a Hydrogen concentration below the maximum concentration specified by the purchaser of the natural gas stream. Accordingly, the Hydrogen stored within the inner pipe of the jacketed pipe assembly (640) can be sold as a Hydrogen output stream (660), and the natural gas with sufficiently low Hydrogen can be sold as a natural gas output stream (670).

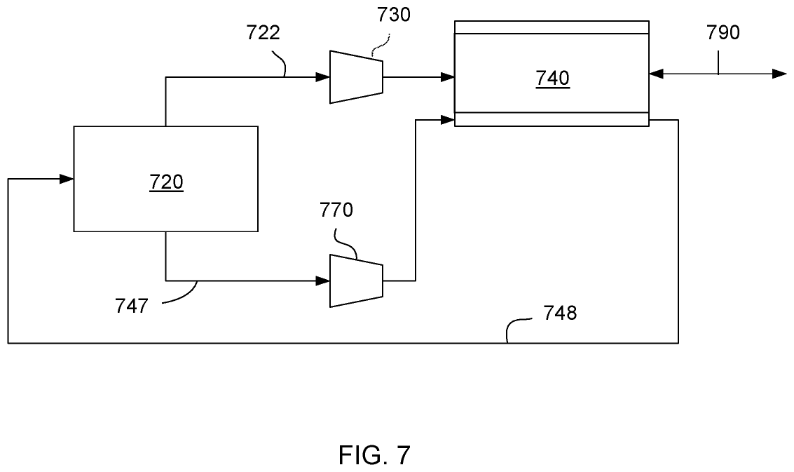

FIG. 7 is a block diagram of a storage system that can store Hydrogen or Helium received from an input/output stream (790) that is not associated with the storage system. In particular, the Hydrogen or Helium can be stored in a jacketed pipe assembly (740) which is the same as (or similar to) the jacketed pipe assembly (140) described in conjunction with FIGS. 1 and 2. Then, a compressor (770) may propel the sweep gas (e.g., carbon dioxide) through a sweep gas loop (747/748), including through an outer annular volume in the jacketed pipe assembly (740) to collect leaked Helium or Hydrogen. The sweep gas loop (747/748) comprises a sweep gas input stream (747) and a sweep gas return stream (748). The sweep gas, including Helium or Hydrogen, is transported to a dedicated separation unit (720) where the Helium or Hydrogen is removed from the rest of the sweep gas. The purified gas stream (722) of Helium or Hydrogen can be pressurized by a compressor (730) and transported back to the jacketed pipe assembly (740) for storage or can be transported back out through the input/output stream (790) for sales and distribution.

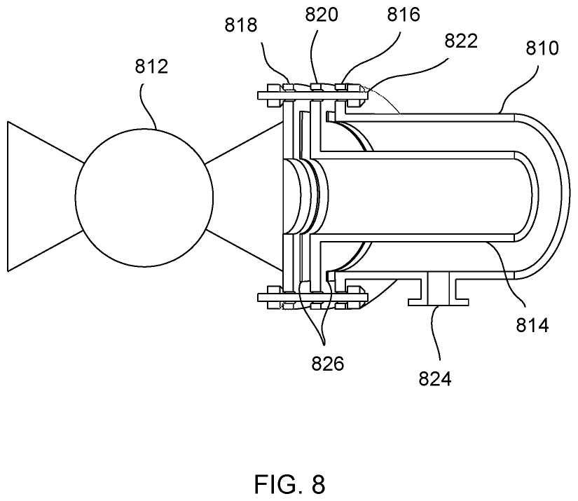

FIG. 8 is a cross-sectional elevation view of a flanged connection between an outer pipe (810), an inner pipe or liner (814), and a valve (812) for a Hydrogen storage or transportation system. The connection prevents high concentrations of Hydrogen from coming into contact with the ends of the outer pipe (810), which can be made of a material that is incompatible with Hydrogen at high partial pressures. In some embodiments, the material of the outer pipe (810) is carbon steel. Specifically, the valve (812) and liner (814), which are made of Hydrogen compatible materials, create a barrier between the outer pipe (810) and the Hydrogen flowing through the inner volume of the liner (814). For instance, the valve (812) may be made of plate steel or any other material that is substantially compatible with Hydrogen. Then, the valve (812) and liner (814) have oversized flanges (818, 820) that extend outward in a radial direction to match the outer diameter and bolting pattern of a flange (816) of the outer pipe (810). Fasteners (822) join the flanges (816, 818, 820) with gaskets (826) disposed therebetween to provide a seal. A sweep gas inlet (824) is offset from the ends of the pipes (810, 824) and the flanged connection, and the sweep gas flows through an annular outer volume between the liner (814) and the outer pipe (810). One or more ridges may extend outward from the liner (814) to channel sweep gas flow into the area between the inlet (824) and the flanged connection between the liner (814) and the outer pipe (810) to prevent concentrations of Hydrogen, or, for example, the sweep gas may flow at a sufficiently high rate to prevent any accumulations or concentrations of Hydrogen. As a result, this arrangement allows an existing outer pipe (810) to have an inner liner added without making significant changes to the existing outer pipe (810) and protect the outer pipe (810).

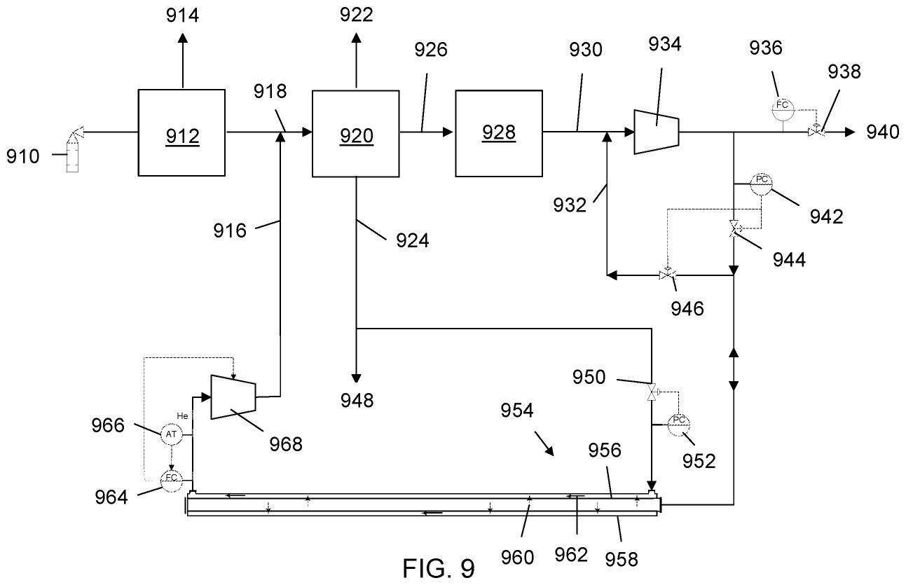

As shown in FIG. 9, a storage system, including a jacketed pipe assembly (954), can be integrated into a process for separating gases from each other. In this embodiment, a raw feed gas from a gas well (910) comprises a mixture of CO₂, H₂S, nitrogen, natural gas, and Helium. The jacketed pipe assembly (954) may include any or all of the components of the embodiments of the jacketed pipe assemblies described in conjunction with FIGS. 1-8.

The components of the raw feed gas from the gas well (910) are separated in stages, with the CO₂ and H₂S removed first in an Acid Gas Removal Unit (AGRU) (912) which is then disposed in a stream (914) for further processing. The combined, sweet gas stream (918) receives a recycled sweep gas (916) and travels to a Nitrogen Rejection Unit (NRU) (920), which creates a vent stream of nitrogen (922), a stream of natural gas (924), and a stream of raw Helium gas (926). The raw Helium gas stream (926) flows to a Helium Purification Unit (HPU) (928), which creates a sales purity Helium product (930). This product (930) can optionally receive additional Helium (932) that is retrieved from the jacketed pipe assembly (954) and be pressurized by a compressor (934) and sold and distributed in a sales output stream (940).

During steady state operation, the purified Helium is pressurized for storage or sales to a predetermined pressure by a compressor (934). In some embodiments, the predetermined pressure is between about 2,000 psig and about 3,200 psig, or about 2,600 psig. Optionally, the compressor (934) comprises multiple compression steps with intercoolers for efficient compression.

The flow of the Helium in the sales output stream (940) can be controlled by a flow controller (936) and a valve (938). The flow controller (936) can include a sensor that detects a flow rate of the Helium as well as a control device that causes the valve (938) to open, close, or hold at an intermediate position. For instance, the flow controller (936) can determine if the flow is above or below a predetermined threshold, and then determine the position of the valve (938), if the position should be changed at all. The flow controller (936) and other controllers can operate individually in a decentralized system or in partial or whole coordination with each other as part of a centralized system.

Next, if more Helium is produced than is immediately sold, then the pressure downstream of the compressor (934) increases, and a pressure controller (942) causes a valve (944) leading to the jacketed pipe assembly (954) to automatically open to maintain a predetermined pressure in the Helium sales header. Conversely, if the valve (938) opens to resume sales, the Helium compressor (934) discharge pressure drops, and the pressure controller (942) causes the valve (944) to close. If the pressure in the compressor (934) discharge continues to fall due to insufficient Helium being available for sale, another valve (946) opens to allow stored Helium to be retrieved and compressed for sales. In this way, the inventory of Helium stored in the jacketed pipe assembly (954) is automatically managed to balance production with sales.

The example sweep gas system can distribute natural gas (948) for sales or other purposes, and the system can use natural gas (924) from the NRU (920) as the sweep gas. The NRU produces sales quality natural gas at moderate pressures, and a pressure controller (952) causes a valve (950) to maintain a constant pressure of sweep gas (962) flowing through the annular outer volume of the jacketed pipe assembly (954) between the inner pipe (956) and the outer pipe (958). As the flow rate of sweep gas increases, the pressure controller (952) causes the valve (950) to open and maintain the pressure of the sweep gas. If the flow rate of the sweep gas is reduced, then the pressure controller (952) causes the valve (950) to close. In some embodiments, the pressure of the sweep gas in the annular outer volume is between approximately 10 to 50 psig, or approximately 30 psig.

Once the sweep gas has passed through the annular outer volume of the jacketed pipe assembly (954) and collected Helium that diffuses or leaks (960) through the inner pipe (956), the sweep gas is pressurized back up to the pressure required to enter the NRU (920) (approximately 800 psig) in a compressor (968) and is blended back into the NRU feed. The flow rate of sweep gas is measured on the discharge of the compressor (968) and is controlled by adjusting the speed of the compressor (968). In some embodiments, the compressor (968) has multiple stages.

Gas composition analyzers (966) are placed at critical locations where the sweep gas exits the annular outer volume of the jacketed pipe assembly (954) to measure the concentration of Helium as the Helium leaks into the sweep gas. If the storage system has multiple branches, additional gas composition analyzers (966) can be placed on the outlet of each branch to identify leak points and adjust sweep gas to individual branches. The measurements provided by the gas composition analyzers (966) are used to determine the required sweep gas flow rate. If the concentration of Helium in the sweep gas is higher than a specified amount, a flow controller (964) causes the flow rate of sweep gas to increase by increasing the speed of the compressor (968). If the concentration of Helium is below a specified amount, the speed of the compressor speed (968) is reduced. A minimum flow rate of the sweep gas is maintained to ensure that leaking Helium passes by a gas composition analyzer (966) in a timely fashion.

In some embodiments, the diffusion of Helium from within the inner pipe (956) to the annular outer volume between the inner pipe (956) and the outer pipe (958) can be determined according to the equation:

$${J}_{H e} = \frac{- {D}_{H e} ( {P}_{i} - {P}_{o} )}{δ R T}$$

where J_{He} is the diffusion flux of Helium (mol/m²s), D_{He} is the diffusivity of Helium (m²/s), Pᵢ is the partial pressure in the inner pipe (Pa), Pₒ is the partial pressure in the annular outer volume (Pa), δ is the thickness of the inner pipe (m), R is a gas constant (J/K mol), and T is the absolute temperature of the Helium (K).

In an exemplary embodiment, the jacketed pipe assembly (954) has an inner pipe (956) that stores high pressure and sales quality Helium and is approximately 1 mile of 24 inch diameter pipe with a pipe wall thickness of approximately 1 inch and a weight of 600 tons. The resulting Helium storage pressure is approximately 2,600 psig, the storage volume is approximately 2.3 million standard cubic feet (MMSCF), and the storage mass is approximately 24,240 lbs. As an example, in order to maintain a 1 psi Helium partial pressure in the annular outer volume, assuming a leak rate of 3.65 standard cubic feet (SCF) of Helium per year per foot of weld, a sweep rate of 73 standard cubic feet per hour (SCFH) is required. Additional sweep gas to capture leaks from valve stems and gaskets may be required. The sweep gas is then compressed and recycled back to the main processing unit for recovery of the Helium. It will be appreciated that embodiments of the present disclosure encompass many different sizes of inner pipe (956) including, but not limited to, outer diameters of 12.75 inches, 18 inches, 32 inches, 36 inches, and 48 inches.

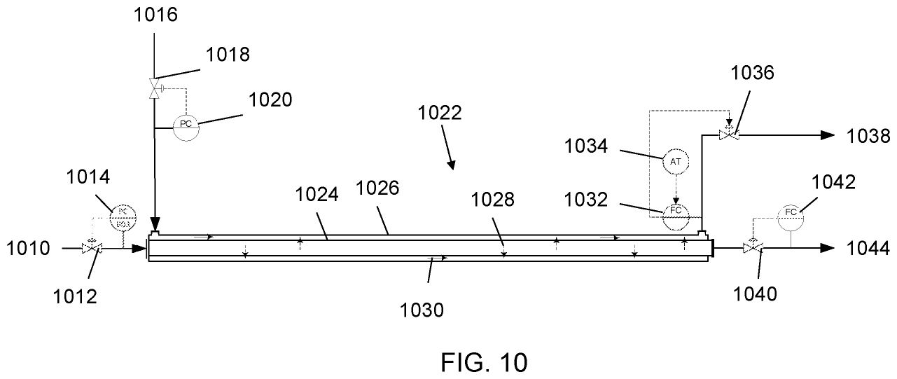

FIG. 10 shows a system for transporting Hydrogen using a jacketed pipe assembly (1022) with an inner pipe or liner (1024) to protect an outer pipe (1026) that may be susceptible to cracking due to excessive exposure to Hydrogen. Hydrogen from a source (1010) is passed into the liner (1024) of the transport pipe system through a pressure control valve (1012). A pressure controller (1014) may cause the valve (1012) to maintain a constant inlet pressure of, for example, approximately 650 psig. At the outlet of the transport pipe system, a flow controller (1042) can cause a valve (1040) to pass the desired amount of Hydrogen through the system for a sales output (1044). This system assures a constant pressure of Hydrogen that is balanced by a constant pressure of natural gas from a natural gas source (1016) entering an annular outer volume between the liner (1024) and the outer pipe (1026) of the transport pipe system through a valve (1018) that is controlled by a pressure controller (1020). The natural gas initially has a lower concentration of Hydrogen than is allowed at the sales point (1038) to allow for the sweep gas (1030) to include the leaked Hydrogen gas (1028) from the inner volume and still comply with the maximum Hydrogen concentration allowed by the buyer. The required sweep gas rate can be determined by the equation:

$$Inlet Gas Rate ( SCFH ) = Leak Rate of H 2 ( SCFH ) ** \frac{Allowable Conc . of H 2}{Final Conc . - Initial Conc}$$

As shown, as long as the initial concentration of Hydrogen is less than the final concentration of Hydrogen, the inlet rate can be increased to account for the additional Hydrogen coming in with the inlet gas. Because the sweep gas flow is adjusted to maintain the Hydrogen concentration below the allowable value for sales where it is measured leaving the system at a gas composition analyzer (1034), it is not necessary for the natural gas to be entirely free of Hydrogen. Hydrogen coming in with the natural gas at the entrance of the sweep gas is measured at the gas composition analyzer (1034), and more sweep gas is automatically added to account for the reduced capacity of the natural gas feeding the annular outer volume to absorb more Hydrogen without exceeding the allowable limit. If additional natural gas is desired, above the sweep gas requirement, a flow controller (1032) can cause the valve (1036) to open more to increase the flow through the annular outer volume to transport additional natural gas, as long as it does not fall below the parameters required by the gas composition analyzer (1034).

In an exemplary embodiment, the outer diameter of the outer pipe (1026) is approximately 24 inches with a pipe wall thickness of approximately 0.5 inches. The allowable pressure of the outer pipe (1026) is approximately 720 psig. The liner (1024) has an outer diameter of approximately 18 inches with a wall thickness of approximately 0.2 inches. The allowable pressure of the liner (1024) is approximately 720 psig. The outer pipe (1026) can be a carbon steel pipe, and the liner (1024) can be a made from a high density polyethylene material. More generally, the outer pipe (1026) is made of a material that is sensitive to Hydrogen, and the liner (1024) is made of another material that is not, or is at least less, sensitive to Hydrogen. The outer pipe (1026) and the liner (1024) can be, for example, 1 mile or more in length. The transport capacity of Hydrogen can be 300 ft/sec or approximately 1.5 billion standard cubic feet per day (BSCFD) or 332.00 lbs/hr. The mass transported or stored in some configurations is approximately 600 lbs. In one example, assuming that the Hydrogen in the liner (1024) and the natural gas in the annular outer volume are running at effectively the same pressure of approximately 650 psig, then diffusion through the liner (1024) is approximately 1.75 SCFH per mile of pipeline. To maintain a partial pressure of Hydrogen at 75 psia, a sweep gas rate of around 16 SCFH is required through the annular outer volume.

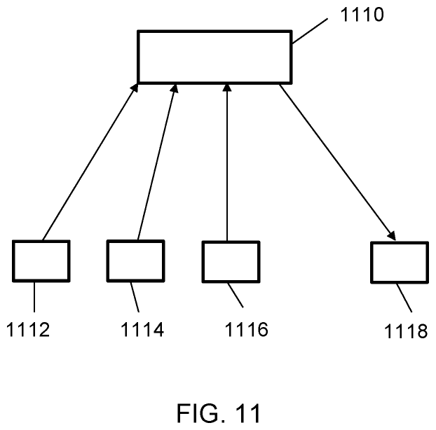

FIG. 11 shows a schematic of a centralized control system for a storage system or transportation system as described herein. Here, a control device (1110) coordinates the various operations of the storage system or transportation system. Specifically, the control device (1110) is configured to receive data from, for example, a pressure sensor (1112) to determine the pressure of a fluid at a location, a flow sensor (1114) to determine a flow rate of a fluid at a location, and a composition sensor (1116) to determine the composition of a fluid at a location. These sensors (1112, 1114, 1116) are exemplary in nature and, optionally, may form part of a localized control system such as a pressure controller, flow controller, gas composition analyzer, etc. as described herein, and embodiments of the present disclosure encompass a variety of other sensors.

The control device (1110) receives and processes data from these sensors (1112, 1114, 1116), then causes the one or more valves (1118) to optionally take action, such as opening, closing, or moving to an intermediate position therebetween. For example, with reference to FIG. 10, the relative concentration of Helium in the natural gas sweep is maintained below a predetermined threshold so that the natural gas can be sold, distributed, and used. If a composition sensor (1116) detects a concentration of Helium above a predetermined threshold, the control device (1110) can cause a valve (1118) to open to increase the flow rate of the natural gas, and thus, decrease the concentration of Helium within the natural gas.

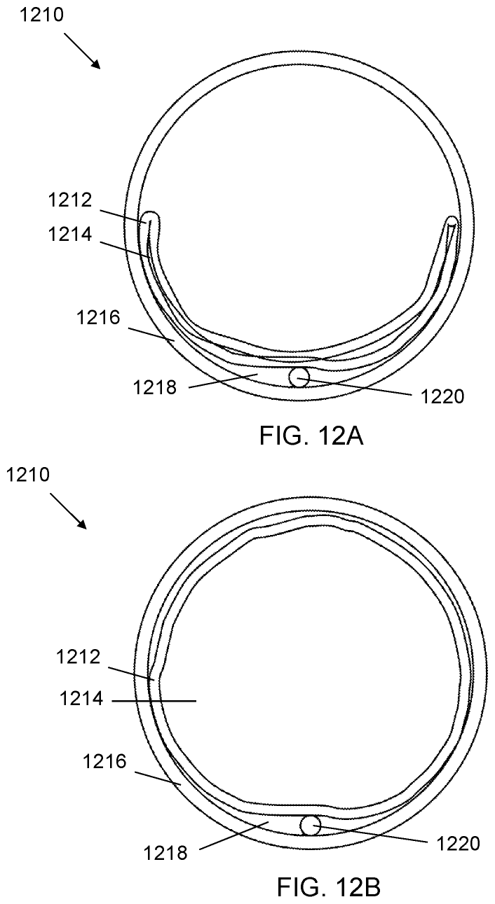

FIGS. 12A and 12B show an inner liner (1212) that has been deployed in an outer pipe (1216) with a line (1220) such as a wire or cable. FIG. 12A shows the inner liner (1212) in a first position where no initial fluid pressure is supplied to a liner volume (1214) within the inner liner (1212), and FIG. 12B shows the inner liner (1212) in a second position where no initial fluid pressure is supplied to an annular volume (1218) between the inner liner (1212) and the outer pipe (1216). Existing pipe infrastructure may be made of carbon steel pipes, which can be damaged by exposure to a product gas, such as Hydrogen. Thus, existing carbon steel pipes can be retrofitted to accommodate a fluid like Hydrogen by introducing an inner liner, a sweep gas, etc. as described herein. As shown in FIGS. 12A and 12B, the inner liner (1212) defines the liner volume (1214) through which a product gas like Hydrogen flows, and the inner liner (1212) and the outer pipe (1216) define the annular volume (1218) through which a sweep gas flows to collect product gas that has leaked through the inner liner (1212) and to protect the outer pipe (1216) from the product gas.

The inner liner (1212) is made of a material that is more lightweight, flexible, and resilient compared to the outer pipe (1216). Therefore, the inner liner (1212) can change shape to balance pressure between the liner volume (1214) and the annular volume (1218). In addition, the inner liner (1212) can resist abrasion as the inner liner (1212) is drawn through the outer pipe (1216). In some embodiments, the material of the inner liner (1212) is sufficient to resist abrasion as the inner liner (1212) is pushed and drawn against the inner surface of the outer pipe (1216). In other embodiments, the inner liner (1212) has an optional abrasion layer to provide similar protection against abrasion.

Regarding pressures, the inner liner (1212) holds a pressure within the liner volume (1214) that is equal to or less than a pressure held by the outer pipe (1216). Thus, the outer pipe (1216) dictates the Maximum Allowable Operating Pressure (MAOP) of the jacketed pipe assembly (1210). As discussed herein, the pressures in the liner volume (1214) and the annular volume (1218) are ideally equal or approximately equal when initially filling the inner liner (1212) so that the inner liner (1212) holds a proper shape within the outer pipe (1216).

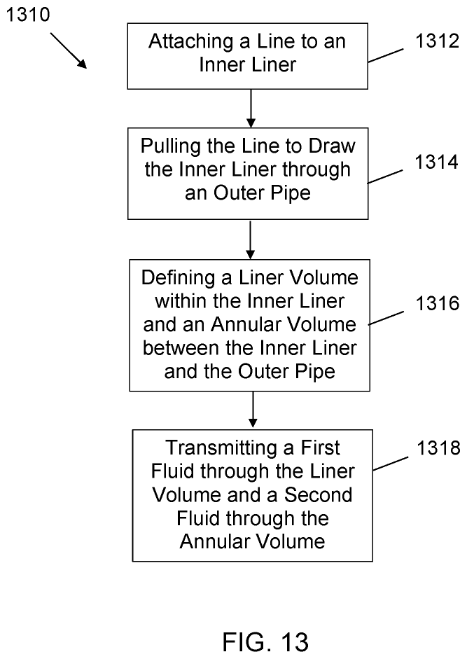

FIG. 13 shows an exemplary process (1310) for deploying an inner liner within an outer pipe, such as a carbon steel pipe. To begin, a line is attached (1312) to the inner liner, and the line has a higher tensile strength than the material of the inner liner. Therefore, any pulling forces are applied to the line rather than the inner liner, which might otherwise tear. The line can be attached to the inner liner by manufacturing the components together such that the line is integrated to the inner liner. Alternatively, the line can be attached to the inner liner by securing or otherwise fastening the line to the inner liner after any manufacturing processes.

Next, the line and the inner liner are drawn (1314) through the outer pipe to position the inner liner substantially within the outer pipe. An engine, motor, or other means of producing physical motion can be attached to the line and pull the line through the interior of the outer pipe. This force on the line causes the inner liner to drag through the outer pipe. As discussed herein, the inner liner can have material properties or layers that protect the inner liner against abrasion during this action.

Once the inner liner is substantially positioned within the outer pipe, the arrangement defines (1316) a liner volume and an annular volume. Specifically, when viewed in cross-section, the inner surface of the inner liner defines the liner volume (1214 in FIG. 12), and the annular volume (1218 in FIG. 12) is defined between an outer surface of the inner liner and the inner surface of the outer pipe. Moreover, each of the liner volume and the annular volume extend from an input end where a product gas is received to an output end where the product gas is delivered.

To transmit (1318) fluids through the liner volume and the annular volume, the product gas is introduced through the input end of the liner volume, and the sweep gas is introduced through the input end of the annular volume. In some embodiments, product gas is added to the liner volume at the same pressure as the sweep gas in the annular volume, and both gasses may optionally flow in the same direction. Then, the liner fills and takes shape progressively toward the outlet end of the liner volume. Additional consideration is made to ensure that any density difference between the gasses in the liner and annular volumes does not cause pressure reversal in one gas but not the other due to changes in elevation that could result in the closing off of one volume. This consequence would likely result in a slugging behavior of the gas, which should be avoided.

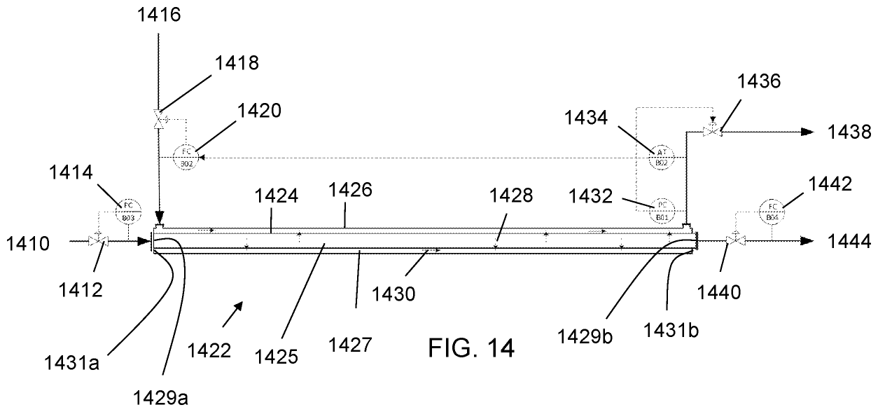

FIG. 14 shows a system for transporting a product gas such as Hydrogen using a jacketed pipe assembly (1422) similar to the one described with respect to FIG. 10. The system in FIG. 14 has a combination of controllers (1414, 1420, 1432, 1442) and respective valves (1412, 1418, 1436, 1440) that can allow for the maximum safe flow of product gas through a liner volume (1425) and a minimum safe flow of sweep gas through an annular volume (1427). The jacketed pipe assembly (1422) has an inner pipe or liner (1424) that defines the liner volume (1425), which extends from an input end (1429a) to an output end (1429b). The annular volume (1427) is defined by the inner liner (1424) and the outer pipe (1426) and extends between an input end (1431a) and an output end (1431b). The relative dimensions of the inner liner (1424), the liner volume (1425), the outer pipe (1426), and the annular volume (1427) can be ascertained based on desired flowrates and pressures within the jacketed pipe assembly (1422) and the system.

Hydrogen from a source (1410) is passed into the liner volume (1425) of the jacketed pipe assembly (1422) through a pressure control valve (1412). A related pressure controller (1414) can cause the valve (1412) to limit pressure within the liner volume (1425) such that, for example, the pressure is a margin away from the MAOP of the outer pipe (1426). At the outlet of the jacketed pipe assembly (1422), a flow controller (1442) can cause a related valve (1440) to pass the desired amount of Hydrogen through the system for a sales output (1444). This flow controller (1442) can be flow control cascaded to the upstream pressure set by the pressure controller (1414).

A sweep gas source (1416) supplies the annular volume (1427) through a related valve (1418) that is controlled by a flow controller (1420). The required sweep gas rate can be determined by the equation described with respect to FIG. 10, and the flow controller (1420) can set the minimum safe flow of sweep gas through the annular volume (1427), if desired. Initially, the sweep gas has a lower concentration of Hydrogen than is allowed at a sales point (1438) to allow for the sweep gas (1430) to include the leaked Hydrogen gas (1428) that diffuses from the liner volume (1425) and still comply with the maximum Hydrogen concentration allowed by the buyer. If a gas composition analyzer (1434) located downstream of the annular volume (1427) detects Hydrogen concentration above a predetermined threshold, the flow controller (1420) can change the flowrate of the sweep gas to maintain the Hydrogen concentration below an allowable value for sales.

A pressure controller (1432) is also located downstream of the annular volume (1427), and the pressure controller (1432) can control a related valve (1436) to set a minimum allowable pressure at the sales point (1438) for the sweep gas. Accordingly, this system allows for the maximum pressure gradient available to develop in view of the MAOP at the upstream or input end and the minimum pressure allowable for operations at the destination or output end. This system also maintains a minimum safe sweep gas flow, which provides as much of the pipeline as possible to the inner liner (1424).

Control systems and devices whether centralized, local, or a combination of both can utilize a digital twin or a digital representation for simulating, operating, controlling, etc. the embodiments described herein. Here, the digital representation of a real system, process, and/or apparatus can inform the simulation, operation, control, etc. of the real system, process, and/or apparatus. For example, an electronic device of a controller system may receive data from a sensor, input the data into the digital representation to determine whether a characteristic is within predetermine thresholds, and then cause a device like a valve or compressor to take action. Referencing the digital representation can allow the electronic device to simulate one or more iterations of the system with a proposed future action to, for example, assess whether part of the system would wear too much or exceed a pressure threshold before actually causing a device like a valve or compressor to take the action.

While various embodiments of the system and method have been described in detail, it is apparent that modifications and alterations of those embodiments will occur to those skilled in the art. It is to be expressly understood that such modifications and alterations are within the scope and spirit of the present disclosure. Further, it is to be understood that the phraseology and terminology used herein is for the purposes of description and should not be regarded as limiting. The use of “including,” “comprising,” or “having” and variations thereof herein are meant to encompass the items listed thereafter and equivalents thereof, as well as additional items. Further, it is to be understood that the claims are not necessarily limited to the specific features or steps described herein. Rather, the specific features and steps are disclosed as embodiments of implementing the claimed systems and methods.

The term “automatic” and variations thereof, as used herein, refer to any process or operation done without material human input when the process or operation is performed. However, a process or operation can be automatic, even though performance of the process or operation uses material or immaterial human input, if the input is received before the performance of the process or operation. Human input is deemed to be material if such input influences how the process or operation is performed. Human input that consents to the performance of the process or operation is not deemed to be “material.”

The term “bus” and variations thereof, as used herein, can refer to a subsystem that transfers information and/or data between various components. A bus generally refers to the collection communication hardware interface, interconnects, bus architecture, standard, and/or protocol defining the communication scheme for a communication system and/or communication network. A bus may also refer to a part of a communication hardware that interfaces the communication hardware with other components of the corresponding communication network. The bus may be for a wired network, such as a physical bus, or wireless network, such as part of an antenna or hardware that couples the communication hardware with the antenna. A bus architecture supports a defined format in which information and/or data is arranged when sent and received through a communication network. A protocol may define the format and rules of communication of a bus architecture.

A “communication modality” can refer to any protocol or standard defined or specific communication session or interaction, such as Voice-Over-Internet-Protocol (“VOIP), cellular communications (e.g., IS-95, 1G, 2G, 3G, 3.5G, 4G, 4G/IMT-Advanced standards, 3GPP, WIMAX™, GSM, CDMA, CDMA2000, EDGE, 1×EVDO, iDEN, GPRS, HSPDA, TDMA, UMA, UMTS, ITU-R, and 5G), Bluetooth™, text or instant messaging (e.g., AIM, Blauk, cBuddy, Gadu-Gadu, IBM Lotus Sametime, ICQ, iMessage, IMVU, Lync, MXit, Paltalk, Skype, Tencent QQ, Windows Live Messenger™ or Microsoft Network (MSN) Messenger™, Wireclub, Xfire, and Yahoo! Messenger™), email, Twitter (e.g., tweeting), Digital Service Protocol (DSP), and the like.

The term “communication system” or “communication network” and variations thereof, as used herein, can refer to a collection of communication components capable of one or more of transmission, relay, interconnect, control, or otherwise manipulate information or data from at least one transmitter to at least one receiver. As such, the communication may include a range of systems supporting point-to-point or broadcasting of the information or data. A communication system may refer to the collection individual communication hardware as well as the interconnects associated with and connecting the individual communication hardware. Communication hardware may refer to dedicated communication hardware or may refer a processor coupled with a communication means (i.e., an antenna) and running software capable of using the communication means to send and/or receive a signal within the communication system. Interconnect refers to some type of wired or wireless communication link that connects various components, such as communication hardware, within a communication system. A communication network may refer to a specific setup of a communication system with the collection of individual communication hardware and interconnects having some definable network topography. A communication network may include wired and/or wireless network having a pre-set to an ad hoc network structure.

The term “computer-readable medium,” as used herein refers to any tangible storage and/or transmission medium that participates in providing instructions to a processor for execution. Such a medium may take many forms, including but not limited to, non-volatile media, volatile media, and transmission media. Non-volatile media includes, for example, non-volatile random access memory (NVRAM), or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, read only memory (ROM), a compact disc read only memory (CD-ROM), any other optical medium, punch cards, paper tape, any other physical medium with patterns of holes, a random access memory (RAM), a programmable read only memory (PROM), and erasable programmable read only memory EPROM, a FLASH-EPROM, a solid state medium like a memory card, any other memory chip or cartridge, a carrier wave as described hereinafter, or any other medium from which a computer can read. A digital file attachment to an e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored. It should be noted that any computer readable medium that is not a signal transmission may be considered non-transitory.

The terms display and variations thereof, as used herein, may be used interchangeably and can be any panel and/or area of an output device that can display information to an operator or use. Displays may include, but are not limited to, one or more control panel(s), instrument housing(s), indicator(s), gauge(s), meter(s), light(s), computer(s), screen(s), display(s), heads-up display HUD unit(s), and graphical user interface(s).

The term “module” as used herein refers to any known or later developed hardware, software, firmware, artificial intelligence, fuzzy logic, or combination of hardware and software that is capable of performing the functionality associated with that element.

The terms “determine,” “calculate,” and “compute,” and variations thereof, as used herein, are used interchangeably and include any type of methodology, process, mathematical operation, or technique.

While the exemplary aspects, embodiments, options, and/or configurations illustrated herein show the various components of the system collocated, certain components of the system can be located remotely, at distant portions of a distributed network, such as a local area network (LAN) and/or the Internet, or within a dedicated system. Thus, it should be appreciated, that the components of the system can be combined in to one or more devices, such as a Personal Computer (PC), laptop, netbook, smart phone, Personal Digital Assistant (PDA), tablet, etc., or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a private branch exchange (PBX) and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Optionally, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In embodiments, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or very-large-scale-integration (VLSI) design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or computer-generated imagery (CGI) script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

What is claimed is:

1. A system for capturing a product gas using a sweep gas, comprising:
an inner conduit having an inner volume, wherein the inner conduit is configured to store the product gas within the inner volume;
an outer conduit positioned around the inner conduit to define an annular volume between the inner and outer conduits, wherein the inner and outer conduits are configured to transport the sweep gas through the annular volume to collect product gas that has leaked from the inner volume to the annular volume;
a separation unit configured to receive the sweep gas from the annular volume and configured to separate the product gas from the sweep gas, wherein the inner and outer conduits are configured to receive the sweep gas from the separation unit through the annular volume; and
a compressor configured to pressurize at least one of the product gas from the inner volume of the inner conduit or the product gas from the separation unit to an output pressure for sales and distribution.

2. The system of claim 1, wherein the product gas is one of Helium or Hydrogen.

3. The system of claim 1, wherein the sweep gas comprises at least one of natural gas, carbon dioxide, or nitrogen.

4. The system of claim 1, further comprising a gas well configured to add more product gas to the sweep gas at a location upstream of the separation unit.

5. The system of claim 1, further comprising:
a first compressor located upstream of the annular volume and configured to increase a pressure of the sweep gas downstream from the separation unit; and
a second compressor located downstream of the annular volume and configured to increase the pressure of the sweep gas upstream of the separation unit.

6. The system of claim 1, further comprising a flow controller configured to detect a flow rate of the product gas for sales and distribution, and the flow controller is configured to control the flow rate with a valve.

7. The system of claim 1, further comprising a pressure controller configured to detect a pressure of the sweep gas upstream of the annular volume, and the pressure controller is configured to control the pressure with a valve.

8. The system of claim 1, further comprising:
a first valve located upstream of the inner volume of the inner conduit; and
a second valve located downstream of the inner volume of the inner conduit, wherein the first and second valves are configured to control the flow of product gas into and out of the inner volume of the inner conduit.

9. A system for capturing a Hydrogen gas using a sweep gas, comprising:
a liner having an inner volume that extends between an input end and an output end, wherein the liner is configured to transport the Hydrogen gas through the inner volume;
a carbon steel pipe positioned around the liner to define an annular volume between the liner and the carbon steel pipe, wherein the annular volume extends between an input end and an output end, and wherein the liner and the carbon steel pipe are configured to transport a sweep gas through the annular volume;
a first pressure controller configured to detect a pressure of the Hydrogen gas upstream of the inner volume, and the first pressure controller is configured to control the pressure of the Hydrogen gas at the input end of the inner volume with a first valve; and
a second pressure controller configured to detect a pressure of the sweep gas downstream of the annular volume, and the second pressure controller is configured to control the pressure of the sweep gas at the output end of the annular volume with a second valve.

10. The system of claim 9, wherein the liner comprises at least one of a high density polyethylene pipe, a reinforced thermoplastic pipe, a polyethylene pipe, or a chlorinated polyvinyl chloride pipe.

11. The system of claim 9, wherein the liner comprises at least one ridge extending into the annular volume to direct the flow of the sweep gas through the annular volume.

12. The system of claim 9, further comprising:
a flow controller configured to detect a flowrate of the sweep gas upstream of the annular volume, and the flow controller is configured to control the flowrate of the sweep gas with a third valve; and
a gas composition analyzer configured to sample a Hydrogen concentration in the sweep gas downstream of the annular volume, wherein, if the gas composition analyzer detects a Hydrogen concentration above a predetermined value, the flow controller increases the flow rate of the sweep gas within the annular volume.

13. The system of claim 9, wherein the sweep gas comprises at least one of natural gas, carbon dioxide, or nitrogen.

14. The system of claim 9, wherein the first pressure controller sets the pressure of the Hydrogen gas at the input end of the inner volume to a value less than a Maximum Allowable Operating Pressure (MAOP) of the carbon steel pipe.

15. The system of claim 9, wherein a line is attached to the liner, the line having a higher tensile strength than the liner.

16. The system of claim 9, further comprising:
a flow controller configured to detect a flowrate of the Hydrogen gas downstream of the inner volume, and the flow controller is configured to control the flowrate of the Hydrogen gas with a fourth valve.

17. A method for deploying an inner liner within a carbon steel pipe, comprising:
providing a line on the inner liner, the line having a higher tensile strength than the inner liner;
drawing the line and the inner liner through the carbon steel pipe until the inner liner is substantially positioned within the carbon steel pipe;
defining a liner volume within the inner liner, wherein the liner volume is configured to transport a Hydrogen gas; and
defining an annular volume between the inner liner and the carbon steel pipe, wherein the annular volume is configured to transport a sweep gas to collect Hydrogen gas that leaks through the inner liner and to protect the carbon steel pipe from Hydrogen gas.

18. The method of claim 17, further comprising:
introducing the Hydrogen gas into an input end of the liner volume at a first pressure; and
introducing the sweep gas into an input end of the annular volume at a second pressure, wherein the input end of the annular volume is proximate to the input end of the liner volume, and wherein the first and second pressures are approximately equal.

19. The method of claim 18, wherein the first and second pressure are within +/−5% of each other on a relative basis.

20. The method of claim 17, wherein the inner liner has an abrasion layer on an outer surface of the inner liner.
